(19) United States
(12) Patent Application Publication
(10) Pub. No.: US 2013/0033140 A1
(43) Pub. Date: Feb. 7, 2013

(54) BRACKET FOR STEPPING MOTOR HAVING WELDING ZONE

(71) Applicant: Jae-Young SUNG, Incheon (KR)

(72) Inventor: Jae-Young SUNG, Incheon (KR)

(73) Assignee: Moatech Co., LTD., Incheon (KR)

(21) Appl. No.: 13/566,182

(22) Filed: Aug. 3, 2012

(30) Foreign Application Priority Data
Aug. 5, 2011 (KR) 10-2011-0078098

(51) Int. Cl. H02K 5/22

(52) U.S. Cl. 310/91

(57) ABSTRACT

Disclosed herein is a bracket for a stepping motor. The bracket includes a plate-shaped welding section, through which a shaft passes, and a welding zone formed on one side of the welding section and having a smaller thickness than the welding section. The bracket has improved welding strength with respect to a housing of the stepping motor.

### CROSS-REFERENCE TO RELATED APPLICATION

This application claims the benefit under 35 U.S.C. §119 of Korean Patent Application No. 10-2011-0078098 filed on Aug. 5, 2011 in the Korean Intellectual Property Office, the entirety of which disclosure is incorporated herein by reference.

### BACKGROUND

1. Technical Field

The present invention relates to a bracket for a stepping motor, and more particularly, to a bracket for a stepping motor, which has a welding zone capable of improving welding strength between the bracket and a housing of the stepping motor.

2. Description of the Related Art

Generally, a stepping motor includes a lead screw formed at one end of a shaft to engage with a pickup head and is driven to move the pickup head in an axial direction.

The background of the present invention is disclosed in Korean Patent No. 10-0836404. This background discloses a bracket which is formed at opposite sides thereof with vertical partition walls, one of which is joined to a first housing.

Typically, the partition wall of the bracket is joined to the first housing by welding.

For example, when the partition wall and the first housing having a thickness of 0.3 mm or more are welded to each other, there can be a problem of deterioration in welding strength therebetween.

Accordingly, although various attempts have been made to improve welding strength, the bracket or the first housing having a relatively small thickness is likely to melt allowing welding residues to intrude into a gap between the bracket and the first housing, thereby causing failure in operation of the motor.

Moreover, when lateral welding is performed through the partition wall at one side of the bracket and a sidewall of the first housing, welding is performed in an area deviated from a desired welding target, causing significantly deteriorated welding strength.

### BRIEF SUMMARY

An aspect of the present invention is to provide a bracket for a stepping motor, which has a welding zone formed on a housing of the stepping motor or the bracket and having a smaller thickness than surrounding regions to allow the welding zone to be easily formed in a vertical direction while improving welding strength, thereby improving resistance to external impact.

Another aspect of the present invention is to provide a bracket for a stepping motor, which has a welding zone capable of preventing a molten pool from intruding into the stepping motor during welding of the bracket to a housing of the stepping motor.

In accordance with an aspect of the present invention, a bracket for a stepping motor is provided.

The bracket for a stepping motor may include a plate-shaped welding section, through which a shaft passes, and a welding zone formed on one side of the welding section and having a smaller thickness than the welding section.

The welding zone may include a plurality of circular unit welding zones.

The unit welding zones may be arranged at constant intervals along a circumference of the welding section to be placed on the circumference of the welding section.

The welding zone and the welding section may have upper surfaces constituting different layers.

The welding zone may be formed by punching one side of the welding section.

According to the present invention, the welding zone is formed on the housing or the bracket to have a smaller thickness than surrounding regions, thereby allowing the welding zone to be easily formed in the vertical direction while improve welding strength, thereby improving resistance to external impact.

In addition, according to the present invention, the welding zone is capable of preventing a molten pool from intruding into a motor during welding of the bracket to the housing of the stepping motor.

### BRIEF DESCRIPTION OF THE DRAWINGS

The above and other aspects, features, and advantages of the present invention will become apparent from the detailed description of the following exemplary embodiments in conjunction with the accompanying drawings, in which:

FIG. 1 is a perspective view of a bracket for a stepping motor welded to a housing of the stepping motor through a welding zone according to one exemplary embodiment of the present invention;

FIG. 2 is a perspective view of a bracket having a welding section according to one exemplary embodiment of the present invention;

FIG. 3 is a perspective view of one embodiment of a welding zone of the welding section welded to a housing of the stepping motor, according to the present invention;

FIG. 4 is a cross-sectional view taken along line I-I′ of FIG. 2;

FIG. 5 is a partially sectional view of another example of a first welding surface of the welding zone according to the present invention;

FIG. 6 is a plan view of another embodiment of the welding zone including unit welding zones according to the present invention;

FIG. 7 is a cross-sectional view taken along line II-II′ of FIG. 6;

FIG. 8 is a plan view of a further embodiment of the welding zone including unit welding zones according to the present invention; and

FIG. 9 is a cross-sectional view taken along line III-III′ of FIG. 8.

### DETAILED DESCRIPTION

Exemplary embodiments of the present invention will now be described in detail with reference to the accompanying drawings.

Stepping Motor

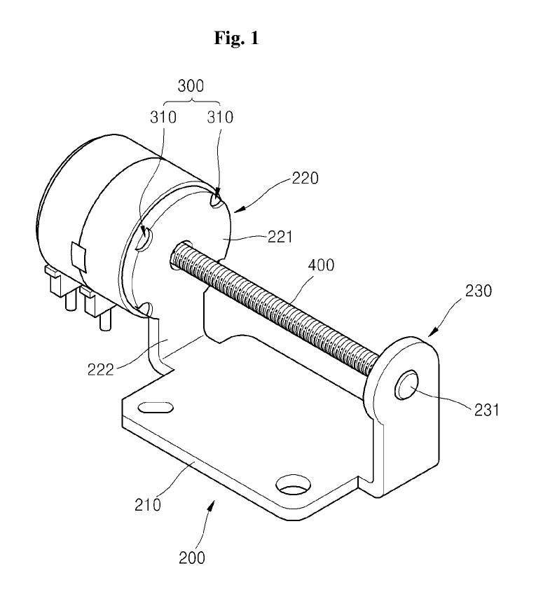

FIG. 1 is a perspective view of a bracket for a stepping motor welded to a housing of the stepping motor through a welding zone according to one exemplary embodiment of the present invention.

Referring to FIG. 1, a stepping motor generally includes a housing 100, a bracket 200 having a welding zone 300, and a shaft 400.

The housing 100 receives a bobbin assembly (not shown) having a coil wound thereon, and a rotor assembly (not shown) disposed within the bobbin assembly and including a magnet rotated by magnetic force from the bobbin assembly.

The bracket 200 is joined to one side of the housing 100 by welding or the like.

The shaft 400 is rotatably provided to the bracket 200 and has a predetermined length.

The shaft 400 is inserted at one end thereof into the magnet of the rotor assembly and is rotatably supported at the other end thereof by a distal end of the bracket 200. Specifically, the other end of the shaft 400 is rotatably supported by a pivot bearing 231 disposed on the distal end of the bracket 200.

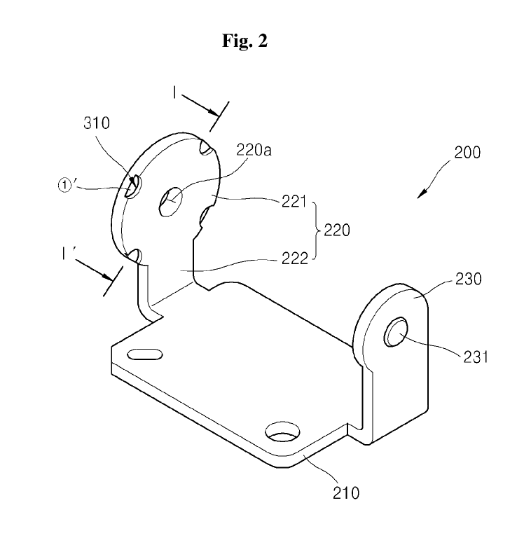

FIG. 2 is a perspective view of the bracket of FIG. 1.

In this embodiment, the bracket 200 includes a plate-shaped base 210, a welding section 220 bent at one side of the base 210 to stand upright, and a support section 230 bent at the other side of the base 210 to stand upright.

The welding section 220 is welded to one side of the housing 100 in a state of being brought into close contact therewith. The welding section 220 is formed at a central region thereof with a through-hole 220a, through which the shaft 400 passes.

The support section 230 is provided at a central region thereof with a pivot bearing 231. The pivot bearing 231 rotatably supports the other end of the shaft 400.

The welding section 220 includes a welding plate 221 and a connection leg 222 extending from one side of the welding plate 221 and connected to one end of the base 210.

The welding plate 221 may have a disc shape.

The welding plate 221 is formed with a welding zone 300. The welding zone 300 provides a region to be welded to the one side of the housing 100.

The welding zone 300 is thinner than the welding plate 221.

Accordingly, the welding zone 300 is stepped from the welding plate 221.

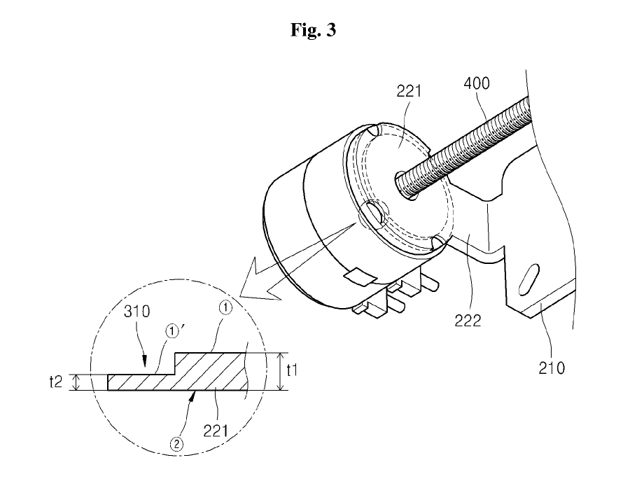

FIG. 3 shows that the welding section of FIG. 2 is joined to one side of the housing.

Referring to FIG. 3, the welding plate 221 has a first surface \textcircled{1} and a second surface \textcircled{2}. The welding plate 221 has a first thickness t1 defined between the first surface \textcircled{1} and the second surface \textcircled{2}.

The welding zone 300 has a first welding surface \textcircled{1}′, which is formed at a lower height than the first surface \textcircled{1}. Further, the welding zone 300 has a second thickness t2 defined between the first welding surface \textcircled{1}′ and the second surface \textcircled{2} and thinner than the first thickness t1 of the welding plate 221 (t1>t2).

Here, the first surface \textcircled{1} and the first welding surface \textcircled{1}′ define a step therebetween.

One Embodiment of Welding Zone

Referring to FIG. 2 and FIG. 3, the welding zone 300 is formed in a groove shape having a predetermined depth on the first surface \textcircled{1} of the welding plate 221.

The welding zone 300 is formed along the circumference of the welding section 220 except for the connection leg 222.

The welding zone 300 includes a plurality of unit welding zones 310.

The unit welding zones 310 are arranged at constant intervals along the circumference of the welding plate 221.

Each unit welding zone 310 is exposed through the circumference of the welding plate 221 and has a semi-circular shape.

Thus, each unit welding zone 310 constitutes a semi-circular shaped groove defining the first welding surface \textcircled{1}′.

The respective unit welding zones 310 may be formed by punching the welding plate 221 at constant intervals along the circumference thereof using a cylindrical punch.

Referring to FIG. 3, the welding section 220 is in close contact with one side of the housing 100.

Here, each unit welding zone 310 has a second thickness t2, which is smaller than the first thickness t1 of the welding plate 221, so that the first welding surfaces \textcircled{1}′ of the unit welding zones 310 can be more closely approach the one side of the housing 100 than the first surface \textcircled{1} of the welding plate 221.

The first welding surface \textcircled{1}′ is a region on which a welding laser beam is irradiated. Preferably, the laser beam is irradiated on a central region of the first welding surface \textcircled{1}′.

By irradiation of the laser beam, a heat affected portion is formed on part of the central region of the first welding surface \textcircled{1}′ of each of the unit welding zones 310 and joined to the one side of the housing 100.

Here, the region having the heat affected portion is within the first welding surface \textcircled{1}′ of each of the unit welding zones 310.

With the heat affected portions of the respective unit welding zones 310, a plurality of welding regions is formed at a plurality of places on the one side of the housing 100. As a result, welding strength between the welding section 220 and the housing 100 can be increased.

Further, since welding is carried out within the first welding surface \textcircled{1}′ of each of the unit welding zones 310, a molten pool flows towards a lateral side of the welding section 221 and is thus prevented from intruding into a gap between the housing 100 and the welding section 220 during welding.

Accordingly, the welding zone according to this embodiment of the invention may provide a sufficiently increased welding area.

Further, the welding zone according to this embodiment may prevent failure of a motor component such as a shaft from occurring due to intrusion of the molten pool into the stepping motor.

Alternatively, the welding zone 300 according to the present invention may be formed as a single groove as shown along a dotted line of FIG. 3.

That is, the welding zone 300 may be realized by a groove of a predetermined depth formed along the circumference of the welding plate 221.

Here, the depth of the groove may be obtained by subtracting the first thickness t1 from the second thickness t2. In other words, the thickness of the welding zone 300 realized by a single groove is the same as the thickness of each of the unit welding zones 310 as described above and defines the first welding surface \textcircled{1}′.

The first welding surface \textcircled{1}′ is a region on which a welding laser beam is irradiated.

The welding zone 300 is formed to a predetermined length along the circumference of the welding plate 221.

The welding zone 300 realized by a single groove may be formed by punching the welding plate 221 along the circumference thereof using a C-shaped punch.

According to this embodiment, an irradiation target point may be changed along the groove.

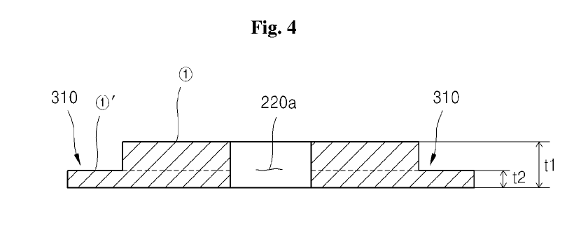

FIG. 4 is a cross-sectional view of the welding section according to the present invention.

Referring to FIG. 4, the welding section 220 and the welding zone 300 described with reference to FIGS. 3 and 4 are formed on different layers.

In other words, a step is formed between each of the unit welding zones 310 and the welding plate 221, which have upper surfaces constituting different layers.

In order to allow the unit welding zone 310 and the welding plate 221 to have upper surfaces constituting different layers, each of the unit welding zones 310 may be formed using a cylindrical punch as described above.

Here, the respective unit welding zones 310 may have a size proportional to the cross-sectional area of the cylindrical punch.

Further, the first welding surface \textcircled{1}′ of each unit welding zones 310 is parallel to the first surface \textcircled{1} of the welding plate 221.

Further, each unit welding zones 310 may have a second thickness t2 ranging from 0.15 mm to 0.3 mm.

Since the second thickness t2 of the respective unit welding zones 310 is smaller than the first thickness t1 of the welding plate, the heat affected portion may be easily formed upon laser welding.

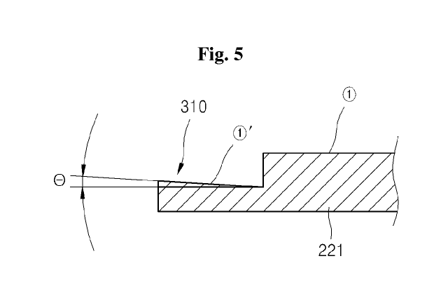

FIG. 5 shows another embodiment of the first welding surface of the welding zone according to the present invention.

Referring to FIG. 5, the first welding surface \textcircled{1}′ of the welding zone 300 may be slanted at a predetermined angle from the circumference of the welding plate 221 towards the center of the welding plate 221.

As described above, the first welding surface \textcircled{1}′ is a region on which a welding laser beam is irradiated.

When the welding laser beam is irradiated on the first welding surface \textcircled{1}′, a region of the first welding surface \textcircled{1}′ receiving the welding laser beam is melted and joined to one side of the housing 100.

In this embodiment, since the first welding surface \textcircled{1}′ is slanted downwards towards the center of the welding plate 221, a molten pool may be guided to an inner side of each of the unit welding zones 310 during welding.

Accordingly, when an irradiation target of the lase welding beam is deviated from the central region of the first welding surface \textcircled{1}′ towards the circumference of the welding plate 221, the molten pool may be prevented from flowing towards the circumference of the welding plate 221.

Another Embodiment of Welding Zone

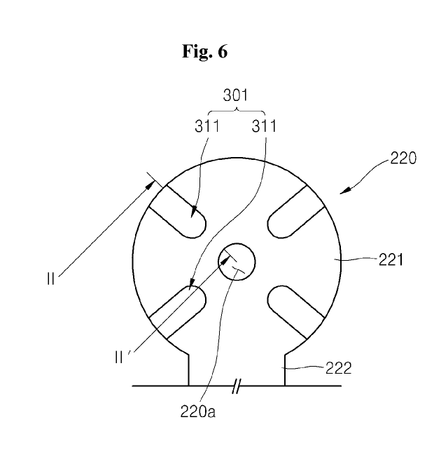

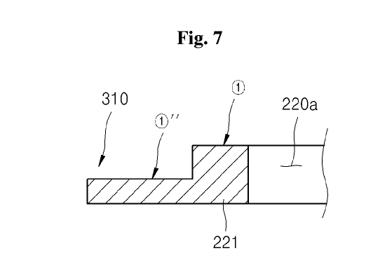

FIG. 6 is a plan view of another embodiment of the welding zone including unit welding zones according to the present invention, and FIG. 7 is a cross-sectional view taken along line II-II′ of FIG. 6.

Referring to FIGS. 6 and 7, a welding zone 301 includes a plurality of unit welding zones 311.

The unit welding zones 311 are arranged at constant intervals along the circumference of the welding plate 221.

Each of the unit welding zones 311 has an elongated groove shape formed from the circumference of the welding plate 221 towards the center thereof.

Each of the unit welding zones 311 formed in an elongated groove shape has a second welding surface \textcircled{1}′, which has a wider area than the first welding surface \textcircled{1}′.

In this embodiment, the respective unit welding zones 311 are formed on a different layer from the welding plate 221 to have a step to the welding plating 221.

Since the second welding surface \textcircled{1}″ has a wider area than the first welding surface \textcircled{1}′, the second welding surface may provide a wider area for irradiation of a welding laser beam.

Further, the second welding surface \textcircled{1}″ may facilitate correction of an irradiation target point of the welding laser beam. In other words, the second welding surface \textcircled{1}″ allows repositioning of the irradiation target point of the welding laser beam within the second welding surface \textcircled{1}″ even in the case in which the irradiation target point of the welding laser beam is deviated from a desired place.

Accordingly, the welding zone according to this embodiment may prevent welding failure between the welding section 200 and the housing 100.

Further Embodiment of Welding Zone

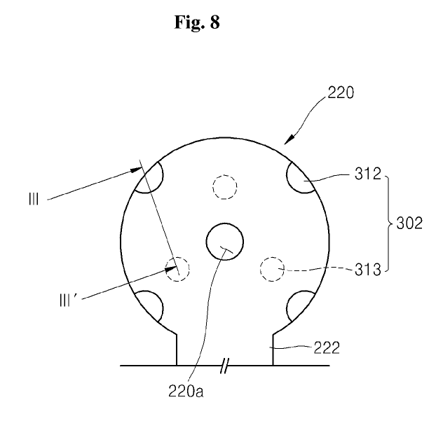

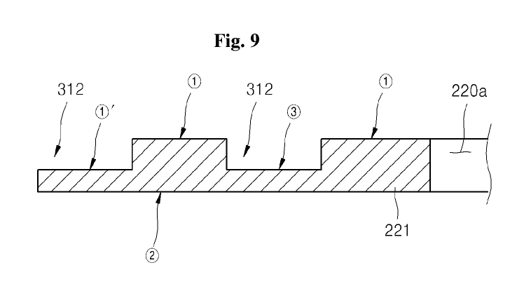

FIG. 8 is a plan view of a further embodiment of the welding zone including unit welding zones according to the present invention, and FIG. 9 is a cross-sectional view taken along line III-III′ of FIG. 8.

Referring to FIGS. 8 and 9, a welding zone 302 may be comprised of a plurality of first unit welding zones 312 and a plurality of second unit welding zones 313.

The plurality of first unit welding zones 312 may have the same configuration as those illustrated with reference to FIG. 1 to FIG. 3.

Each of the first unit welding zones 312 has a first welding surface \textcircled{1}′ and a second thickness t2.

Each of the second unit welding zones 313 may be formed in a circular groove shape having a predetermined depth.

Each of the second unit welding zones 313 has a third welding surface \textcircled{3} and a third thickness t3.

The third thickness t3 of each second unit welding zone 313 may be substantially the same as the second thickness t2. The third welding surface \textcircled{3} is formed substantially along the same line as that of the first welding surface \textcircled{1}′.

The first and second unit welding zones 312, 313 are formed using a cylindrical punch.

The first unit welding zones 312 are formed by punching the welding plate 221 at constant intervals along the circumference thereof using a cylindrical punch.

The second unit welding zones 313 are formed around the center of the welding plate 221 using a cylindrical punch.

The first and second unit welding zones 312, 313 may have different sizes determined according to the cross-sectional area of the punch to be used.

For example, the second unit welding zones 313 may be larger than the first unit welding zones 312. With this structure, it is possible to regulate a surface area of the region to be welded.

In addition, the first and second unit welding zones 312, 313 may have different thicknesses determined by punching strength of the punch.

For example, when the third thickness t3 is lower than the second thickness t2, the second unit welding zones 313 may provide higher welding strength than the first unit welding zones 312 upon welding the welding section 200 to the housing 100.

Further, the first unit welding zones 312 as shown in FIG. 6 to FIG. 8 may be used.

In particular, since each of the second unit welding zones 313 has a circular groove shape, a molten pool formed by irradiation of a welding laser beam on the third welding surface \textcircled{3} may be prevented from flowing out of the welding section 200.

According to the embodiments, the upper surfaces of the welding section of the bracket (first surface, first welding surface, second welding surface, third welding surface) are melted to be joined to one side of the housing with which the bracket is brought into contact, thereby enabling efficient increase in welding strength.

According to the embodiments, the welding section has a stepped welding zone having a thickness of 0.15 mm˜0.3 mm, such that the welding zone can be easily melted upon irradiation of a welding laser beam on the welding zone to facilitate welding.

According to the embodiments, a welding zone includes a plurality of unit welding zones formed along the circumference of the welding section, thereby providing a sufficiently increased welding area.

According to the embodiments, welding strength between the housing and the bracket is increased, thereby improving durability of a motor even after product testing or falling.

According to the embodiments, the welding section is welded to the housing via an upper surface thereof, preventing welding residues from flowing into a gap between the housing and the bracket causing failure of the motor.

Although some exemplary embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A bracket for a stepping motor comprising:
a plate-shaped welding section, through which a shaft passes; and
a welding zone formed on one side of the welding section and having a smaller thickness than the welding section.

2. The bracket according to claim 1, wherein the welding zone comprises a plurality of circular unit welding zones.

3. The bracket according to claim 2, wherein the unit welding zones are arranged at constant intervals along a circumference of the welding section to be placed on the circumference of the welding section.

4. The bracket according to claim 1, wherein the welding zone and the welding section have upper surfaces constituting different layers.

5. The bracket according to claim 1, wherein the welding zone is formed by punching one side of the welding section.
